(19) United States
(12) Patent Application Publication
(10) Pub. No.: US 2026/0322273 A1
(43) Pub. Date: Oct. 15, 2026

(54) VOLTAGE-DOUBLER CIRCUIT CONTROL

(71) Applicant: Murata Manufacturing Co., Ltd., Nagaokakyo-shi, Kyoto-fu (JP)

(72) Inventor: Takayuki Tange, Milton Keynes (GB)

(21) Appl. No.: 19/101,265

(22) PCT Filed: Aug. 10, 2023
(86) PCT No.: PCT/US2023/030008

§ 371 Date: Feb. 5, 2025

Related U.S. Application Data
(60) Provisional application No. 63/398,040, filed on Aug. 15, 2022.

(51) Int. Cl. H02M 3/335; H01F 27/28

(52) U.S. Cl. CPC H02M 3/335; H01F 27/28

(57) ABSTRACT

A circuit includes first and second output terminals; a transformer including a primary winding and a secondary winding, the secondary winding includes a tap that divides the secondary winding into first and second secondary windings; a rectifier circuit connected to the secondary winding; and a voltage-doubler circuit connected to the tap such that the voltage-doubler circuit receives a first voltage from both the first and the second secondary windings and a second voltage from only the second secondary winding.

### CROSS REFERENCE TO RELATED APPLICATIONS

This application claims the benefit of U.S. Patent Application No. 63/398,040 filed on Aug. 15, 2022. The entire contents of each application are hereby incorporated by reference.

### BACKGROUND OF THE INVENTION

### 1. Field of the Invention

The present invention relates to voltage-doubler circuits. More specifically, the present invention relates to voltage-double circuits that can be used with transformers.

### 2. Description of the Related Art

FIG. 1 shows a known voltage-doubler circuit connected to the secondary winding S1 of a transformer TX2. In addition to the secondary winding S1, the transformer TX2 also includes a primary winding P1. “Primary side” refers to circuitry directed connected to the primary winding P1, and “secondary side” refers to circuitry directed connected to the secondary winding S1. The voltage-doubler circuit includes capacitors C3, C4 connected in series with each other and connected in parallel across the output terminals Vout+, Vout−. Rectifier diodes D1, D4 are also connected to the secondary winding S1. The cathode of diode D4 is connected to the anode of diode D3. A first node defined by the connection of the cathode of diode D4 and the anode of diode D3 is connected to a first end of the secondary winding S1, i.e., the dotted end of the secondary winding S1. Each of the capacitors C3, C4 includes first and second terminals. The first terminal of the capacitor C4 is connected to the cathode of the diode D1 and to the output terminal Vout+. The second terminal of the capacitor C4 is connected to the first terminal of the capacitor C3. A second node defined by the connection between the second terminal of the capacitor C4 and the first terminal of the capacitor C3 is connected to a second end of the secondary winding S1, i.e., the non-dotted end of the secondary winding S1. The second terminal of the capacitor C3 is connected to the anode of the diode D4 and the output terminal Vout−.

Known voltage-doubler circuits provide an output voltage that is twice the AC input voltage. Input-voltage tolerances are doubled by known voltage-doubler circuits, which greatly affects the output voltage. That is, small changes in the input voltage results in large changes in the output voltage. As shown in FIG. 1, if the AC voltage applied to the voltage-double circuit is created by a transformer TX2, when the number of turns in the secondary winding is increased by one, the output voltage of the voltage-doubler circuit is increased by twice the transformer's turns ratio. Because of these issues, designing circuits with a known voltage-doubler circuit to provide a target output voltage is difficult. The output voltage of known voltage-doubler circuits cannot be controlled by adjusting the duty cycle of one or more power switches in a primary circuit. The output voltage of the voltage-doubler circuit is always constant, regardless of the ON and OFF timing of the power switch in the primary circuit. To avoid these problems with known voltage-doubler circuits, it known to use full-bridge rectifier circuit instead of a voltage-doubler circuit. But a full-bridge rectifier does not double the voltage.

### SUMMARY OF THE INVENTION

To overcome the problems described above, preferred embodiments of the present invention provide voltage-doubler circuits that are connected to a tapped secondary winding so that the output voltage can more precisely be controlled by adjusting the duty cycle of one or more power switches in the primary circuit, reducing the effect of input-voltage tolerances on the output voltage.

According to a preferred embodiment of the present invention, a circuit includes first and second output terminals; a transformer including a primary winding and a secondary winding, the secondary winding includes a tap that divides the secondary winding into first and second secondary windings; a rectifier circuit connected to the secondary winding; and a voltage-doubler circuit connected to the tap such that the voltage-doubler circuit receives a first voltage from both the first and the second secondary windings and a second voltage from only the second secondary winding.

The voltage-doubler circuit can include first and second capacitors connected in series with each other and connected in parallel with the first and second output terminals. The first voltage can be applied to the first capacitor and the second voltage can be applied to the second capacitor such that an output voltage across the first and the second output terminals can be a sum of the first voltage and the second voltage. The rectifier circuit can include first and second diodes. Each of the first and the second capacitors can include first and second ends; each of the first and the second diodes can include an anode and a cathode; the anode of the first diode can be connected to the first end of the first secondary winding; a cathode of the second diode can connected to the second end of the first secondary winding and to the first end of the second secondary winding; the first terminal of the first capacitor can be connected to the cathode of the first diode and to the first output terminal; the second terminal of the first capacitor can be connected to the first terminal of the second capacitor; a node defined by a connection between the second terminal of the first capacitor and the first terminal of the second capacitor can be connected to the second end of the second secondary winding; and the second terminal of the second capacitor can be connected to the anode of the second diode and the second output terminal.

The circuit can further include a substrate, where the transformer can be embedded in the substrate. The primary winding and the secondary winding can be interleaved.

According to a preferred embodiment of the present invention, a converter includes first and second input terminals, the circuit of one of the various other preferred embodiments of the present invention, and an integrated circuit (IC) connected to the first and the second input terminals and the primary winding.

The converter can further include a load-compensation circuit connected to the second input terminal. The load-compensation circuit can include a resistor connected to the second input terminal and an operational amplifier connected across the resistor. The converter can further include a third output terminal. The third output terminal can be connected to the voltage-doubler circuit. The converter can further include a series regulator, where the third output terminal can be connected to the series regulator.

During an OFF period of the IC, the first voltage can be applied to the first capacitor, and during an ON period of the IC, the second voltage can be applied to the second capacitor.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 is a circuit diagram of known voltage-doubler circuit.

FIG. 2 is a circuit diagram of a voltage-doubler circuit connected to a tapped secondary winding of a transformer.

FIGS. 3A and 3B are circuit diagrams of half-bridge DC-DC converters with the voltage-doubler circuit of FIG. 2.

FIG. 4 is circuit diagram of half-bridge DC-DC converter with the voltage-doubler circuit of FIG. 2 and with a first load-compensation circuit.

FIG. 5 is circuit diagram of half-bridge DC-DC converter with the voltage-doubler circuit of FIG. 2 and with a second load-compensation circuit.

FIGS. 6 and 7 are circuit diagrams of half-bridge DC-DC converters with the voltage-doubler circuit of FIG. 2 that can be used in gate-driver applications.

FIGS. 8, 9, 10, and 11 are perspective, top, bottom, and sectional views of the primary and the secondary windings of a transformer that can be used with the voltage-doubler circuit of FIG. 2.

FIG. 12 shows simulations of two known voltage-doubler circuits with different turns ratios and of the voltage-doubler circuit of FIG. 2.

FIG. 13 show bench test results showing the relationship between the output voltage and the output current of the voltage-doubler circuits shown in FIG. 10.

FIG. 14 shows load regulation of the converters of FIGS. 3A and 3B at different primary voltages.

FIG. 15 are tables showing the improvement in input-voltage tolerance for different turns ratios during the ON-and OFF-periods.

### DETAILED DESCRIPTION OF PREFERRED EMBODIMENTS

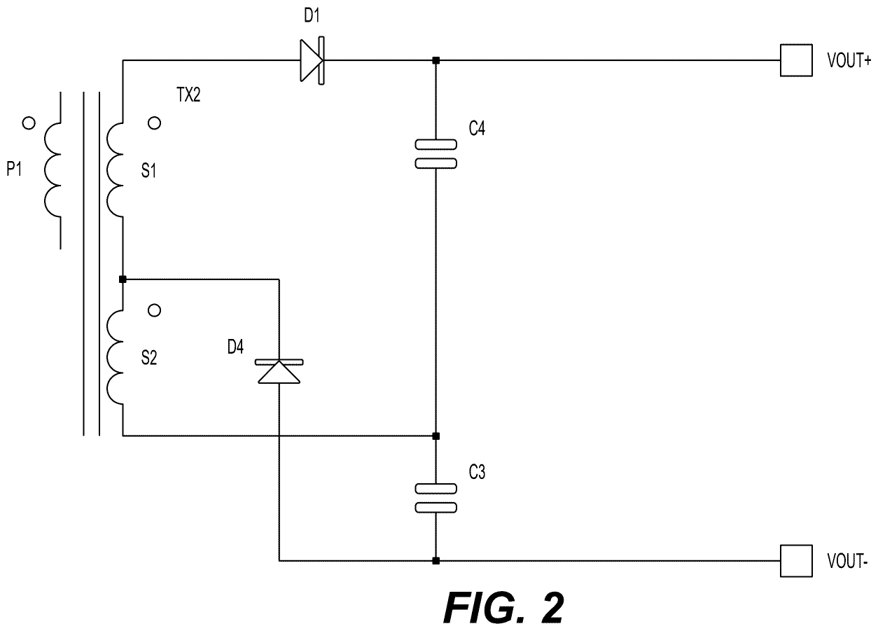

FIG. 2 shows a circuit that includes a transformer TX2 with primary winding P1 and a secondary winding, where the secondary winding is tapped to divide that secondary winding into first and second secondary windings S1, S2; a rectifier circuit connected to the secondary winding; and a voltage-doubler circuit connected to the secondary winding, the rectifier circuit, and output terminals Vout+, Vout−. Connecting the voltage-doubler circuit to the tapped secondary winding allows finer resolution in determining the output voltage, making designing a circuit using the voltage doubler easier.

The voltage-doubler circuit includes capacitors C3, C4 connected in series with each other and connected in parallel across the output terminals Vout+, Vout−. Rectifier diodes D1, D4 are also connected to the first and the second secondary winding S1, S2. It is also possible to use, for example, synchronous rectifiers instead of rectifier diodes D1, D4. The anode of the diode D1 is connected to the first end of the first secondary winding S1, i.e., the dotted end of the first secondary winding S1. The cathode of the diode D4 is connected to the tapped secondary winding, i.e., connected to the second end or the non-dotted end of the first secondary winding S1 and to the first end or the dotted end of the second secondary winding S2. Each of the capacitors C3, C4 includes first and second terminals. The first terminal of the capacitor C4 is connected to the cathode of the diode D1 and to the output terminal Vout+. The second terminal of the capacitor C4 is connected to the first terminal of the capacitor C3. A second node defined by the connection between the second terminal of the capacitor C4 and the first terminal of the capacitor C3 is connected to a second end of the second secondary winding S2, i.e., the non-dotted end of the second secondary winding S2. The second terminal of the capacitor C3 is connected to the anode of the diode D4 and the output terminal Vout−.

The number of turns in the primary windings can be the same as or can be different from the sum of the number of turns in the first secondary windings S1 and in the second secondary windings S2. The first and the second secondary windings S1, S2 can have the same or a different number of turns. If the first and the second secondary windings S1, S2 include the same number of turns, then the capacitor C4 can be charged to a voltage twice the voltage of the capacitor C3.

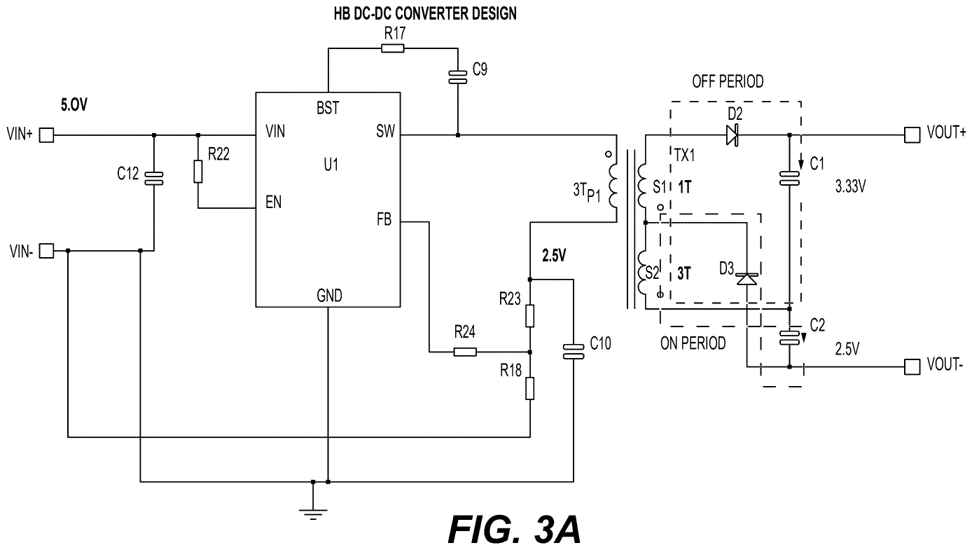

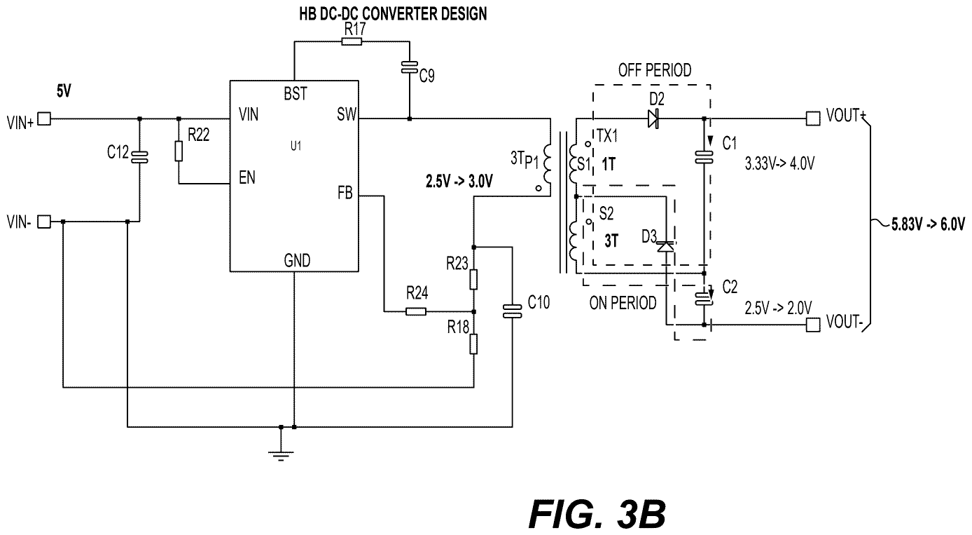

FIG. 3A shows a half-bridge DC-DC converter with the voltage-doubler circuit of FIG. 2 connected to the first and the second secondary windings S1, S2 of the transformer TX1. The converter in FIG. 3A includes input terminals Vin+, Vin− that are connected to an integrated circuit (IC) U1. The IC U1 is connected to the primary winding P1 of the transformer TX1. The first and the second secondary windings S1, S2 of the transformer TX1 are connected to the voltage-doubler circuit including the first and the second capacitors C1, C2 that are connected in parallel across the output terminals Vout+, Vout−. First capacitor C1 in FIG. 3A corresponds to capacitor C4 in FIG. 2, and second capacitor C2 in FIG. 3A correspond to capacitor C3 in FIG. 2 The IC U1 can be any suitable IC, including, for example, a point-of-load IC. The IC U1 can be a fully integrated, high-frequency, synchronous, rectified, step-down, switch-mode converter with internal power switches, including, for example, metal-oxide-semiconductor field-effect transistors (MOSFETs). The IC U1 can provide about 1 A of continuous output current over a wide input range. The IC U1 can use synchronous mode operation to achieve higher efficiency over the output current load range.

The IC U1 can include various components of a converter, including, for example, two power switches connected in series and can include charge-pump circuitry. As shown in FIGS. 3A and 3B, the IC U1 can include an input voltage terminal VIN; an enable terminal EN that turns on the IC U1 when a voltage is applied and that turns off the IC U1 when no voltage is applied; a boost terminal BST that is connected to charge-pump circuitry inside the IC U1 to drive, for example, a high-side n-channel power switch inside the IC U1; a switching-node terminal SW connected to a node between two series-connected, n-channel power switches; a feedback terminal FB that monitors the output of the IC U1; and a ground terminal GND. The switching-node terminal SW can be connected to a magnetic component within the IC U1. The feedback terminal FB can be connected to the output voltage of the IC U1 through a voltage divider, e.g., resistors R23 and R18 in FIG. 3A, to keep the output voltage of the IC U1 the same over time or constant.

The capacitor C12 is an input capacitor that is connected between the input terminals Vin+, Vin− and that can filter out any input-voltage ripple to avoid instability in the IC U1. The resistor R22 is a current-limit resister that is connected between the input terminal Vin+ and the enable terminal EN that limits current flow into enable terminal EN to protect the IC U1 from any electrical over-stress.

Resistor R17 and capacitor C9 are connected in series to each other and are connected between the boost terminal BST and the switch-node terminal SW. The resistor R17 is a charge-pump resistor and the capacitor C9 is charged by the switching voltage that drives the power switch inside the IC U1. The discharging current of capacitor C9 flows through resistor R17, and the discharging time of the capacitor C9 can be delayed by the resistor R17, reducing switching noise. The capacitor C9 is part of a charge-pump circuit that driver the power switch inside the IC U1.

Resistors R23 and R18 can be connected in series between the primary winding P1 and the input terminal Vin−, and the capacitor C10 can also be connected between the primary winding P1 and the input terminal Vin−. The resistors R23 and R18 can define a voltage divider that divides the primary output voltage of the transformer TX1. An operational amplifier (OP amp) can be included within the IC U1. The output of the internal OP amp can provide a duty-cycle signal to the internal power switches through driver circuitry and logic circuitry. The duty-controlled internal power switch that is sensed by resistor R23 makes the transformer's output voltage the same, regardless of the time, i.e., the transformer's output is constant.

The resistor R24 is connected to the feedback terminal FB and to a node of the voltage divider defined by resistors R23 and R18, i.e., the resistor R24 is connected to the node between the resistors R23 and R18. The resistor R24 can provide gain control of the OP amp within the IC U1. That is, the resister R24 can reduce the output gain of the internal OP amp of the IC U1.

The capacitor C10 is a primary voltage output capacitor of the transformer TX1, which can help stabilize operation of the IC U1.

In FIG. 3A, the primary windings P1 includes three turns, the first secondary winding S1 includes one turn, and the second secondary winding S2 includes three turns. It is possible that number of turns in the primary windings P1, the first secondary winding S1, and the second secondary winding S2 be different than the number of turns shown in FIG. 3A. In FIG. 3A, the input voltage is 5.0 V, but other input voltages are possible. Also, the primary voltage is about 2.5 V (within manufacturing and/or measurement tolerances), but other primary voltages are also possible. As shown in FIG. 3A, during the OFF period of the IC U1 when positive current is flowing through the primary winding P1, the first capacitor C1 is charged using both the first and the second secondary windings S1, S2 so that the transformer turns ratio is 3:4, which results in the first capacitor C1 being charged to about 3.33 V (within manufacturing and/or measurement tolerances), and during the ON period of the IC U1 when negative current is flowing through the primary winding P1, the second capacitor C2 is charged using only the second secondary winding S2 so that the transformer turns ratio is 3:3, which results in the first capacitor C1 being charged to about 2.5 V (within manufacturing and/or measurement tolerances). Thus, the output voltage at the output terminal Vout+ is about 5.83 V (within manufacturing and/or measurement tolerances), i.e., the sum of the voltages on the first and the second capacitors C1, C2.

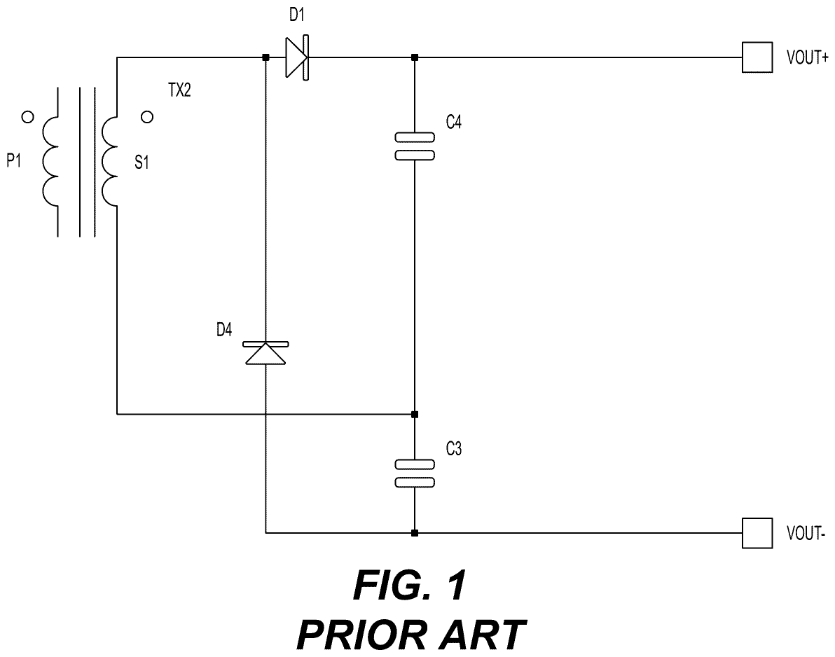

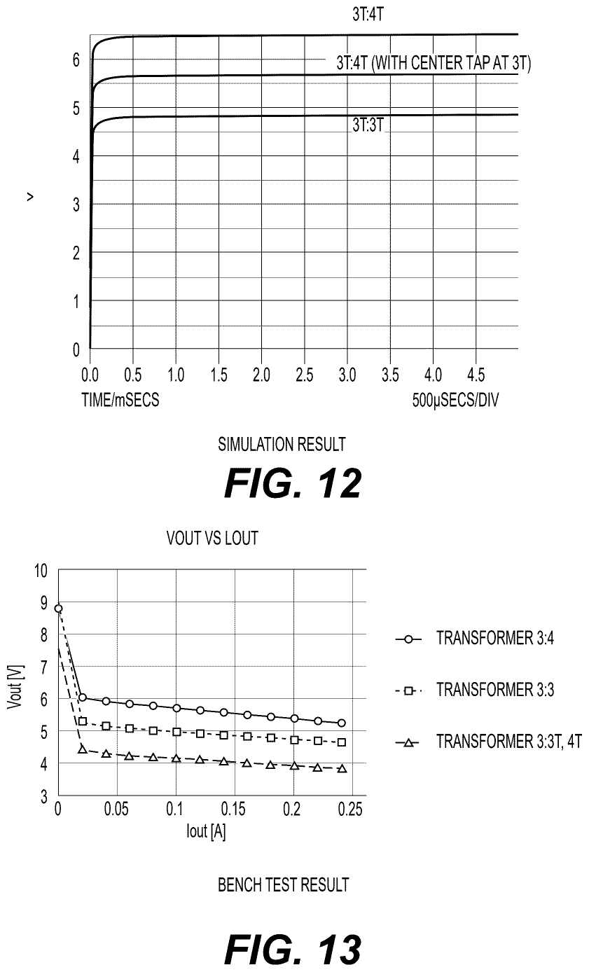

FIG. 12 shows simulation results for different converters. The top line shows the output voltage over time of a converter with the known voltage-doubler circuit of FIG. 1 and with a turns ratio 3:4, and the bottom line shows the output voltage over time of a converter with the known doubler circuit of FIG. 1 but with a turns ratio 3:3. The middle line shows the output voltage over time of a converter with the voltage-doubler circuit of FIG. 2 and with a turns ratio of 3:4, where the secondary winding is tapped at the third turn so that the first secondary winding S1 includes one turn and the second secondary winding S2 includes three turns, similar to FIG. 3A. The output voltage of the top line increases to about 6.67 V, and the output voltage of the bottom line increases to about 5.0 V. The output voltage of the middle line increases to about 5.83 V, which is in between output voltages of the top and the bottom lines. These simulation results are verified in FIG. 13 that shows bench test results of the converters in FIG. 12.

FIG. 3B shows a converter with a similar topology and circuit layout of the converter of FIG. 3A. In FIG. 3B, the primary voltage is about 3.0 V instead of about 2.5 V, which results in the first capacitor C1 being charged to about 4.0 V and in the second capacitor C2 being charged to about 2.0 V (=5 V−3 V). Thus, the output terminal Vout+ is at about 5.83 V (within manufacturing and/or measurement tolerances), i.e., the sum of the voltages on the first and the second capacitors C1, C2.

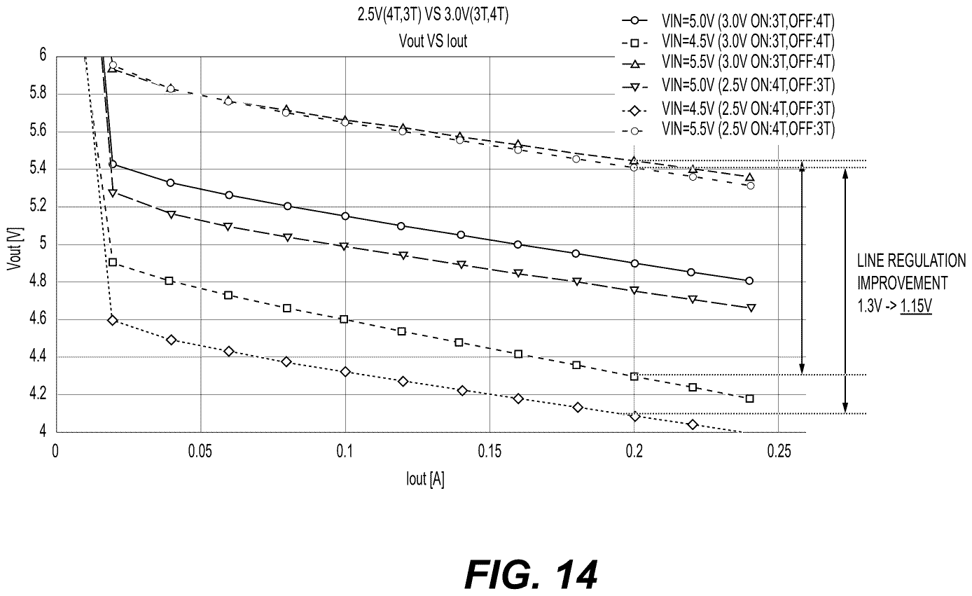

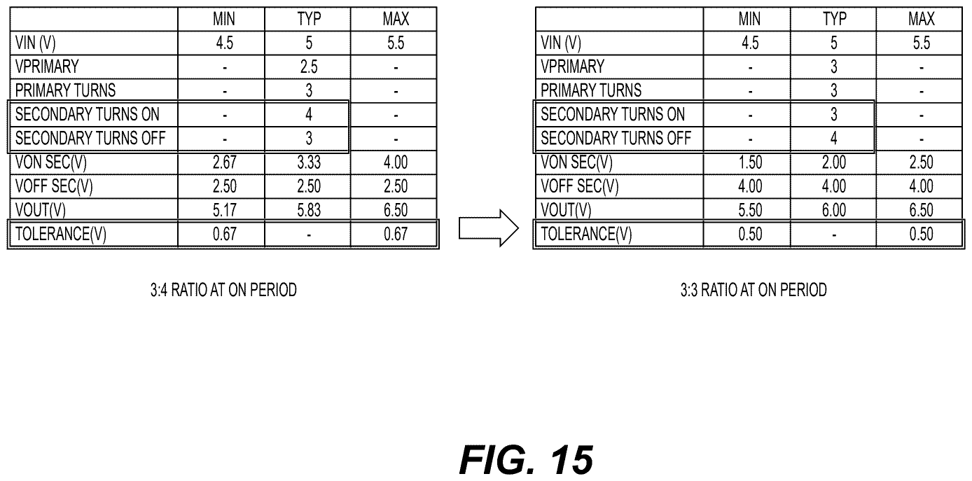

Because the FB voltage of IC U1 is constant, the primary voltage during the OFF period voltage is also always constant, regardless of input voltage tolerances because the IC U1 keeps the same feedback voltage. On the other hand, during the ON period, input voltage tolerance is appeared by the transformer ratio during ON period. As shown in the two tables shown in FIG. 15, if the transformer ratio is small, then the effect of the input-voltage tolerance on the output voltage is also small, which improves line regulation. FIG. 15 includes tables with calculations that show output-voltage tolerance improvement. Thus, during the ON period, fewer turns can be included in the secondary windings by only including the second secondary winding S2, which reduces the turns ratio and thus the effect of the input-voltage tolerances on the output voltage. FIG. 14 shows improvement in the line regulation when the input voltage varies from 4.5 V-5.5 V in a converter that uses a 3.0 V primary voltage, three turns in the secondary winding during the ON period, and four turns in the secondary winding during the OFF period, compared to a converter that uses a 2.5 V primary voltage, four turns in the secondary winding during the ON period, and three turns in the secondary winding during the OFF period.

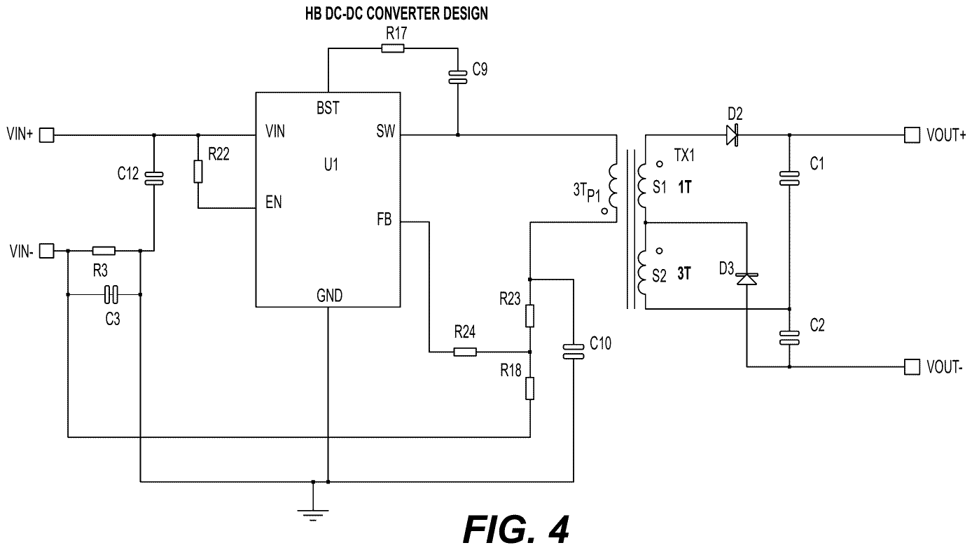

FIG. 4 shows a converter similar to the converters shown in FIGS. 3A and 3B but with a load compensation circuit on the primary side. The load compensation circuit can include resistor R3 and capacitor C3 that are connected in parallel with each other. A first end of the resistor R3 and a first end of the capacitor C3 can be connected to the input terminal Vin-and the voltage divider, and a second end of the resistor R3 and the second end of the capacitor C3 can be connected to ground and capacitor C12. Normally, the output voltage Vout is load regulated without any feedback or primary control. But when the duty cycle is controlled based the load, the regulation of the output voltage Vout is improved. In FIG. 4, the voltage drop across the resistor R3 from the input current is representative of the output current. The output voltage is increased by controlling the duty cycle, canceling out the voltage drop by the output load. The current through resistor R3 can have a pulsed waveform without the capacitor C3. The capacitor C3 filters the pulsed waveform into DC voltage to affect the FB voltage from the voltage divider.

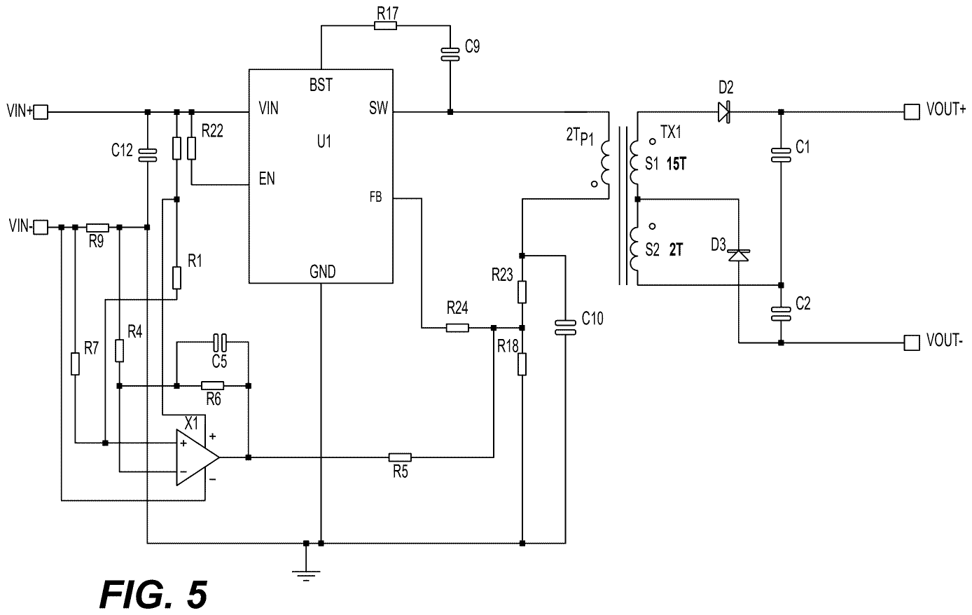

FIG. 5 shows a converter similar to the converter shown in FIG. 4 with another load compensation circuit on the primary side. The load compensation circuit is connected to the input terminals Vin+, Vin− and to the node of the voltage divider between resistors R23 and R18. The load compensation circuit includes resistor R9 that is similarly arranged as resistor R3 in FIG. 4. A first end of the resistor R9 is connected to the input terminal Vin−, and a second end of the resistor R9 is connected to the capacitor C12 and ground. The load compensation circuit also includes differential OP amp X1 that includes two inputs connected across the resistor R9. The noninverting input of the differential OP amp X1 is connected to the first end of the resistor R9 and the input terminal Vin-through resistor R7 and is connected to input terminal Vin+ through resistor R1, and the inverting input of the differential OP amp X1 is connected to the second end of the resistor R9 through resistor R4 and is connected to a feedback circuit including resistors R6 and capacitor C5. The positive power-supply voltage of the differential OP amp X1 is connected to the input terminal Vin+, and the negative power-supply voltage of the differential OP amp X1 is connected to the input terminal Vin−. Resistor R5 is connected to the output of the differential OP amp X1 and to the node of the voltage divider between resistors R23 and R18. In FIG. 5, the differential OP amp X1 is connected across the resistor R9 to amplify the signal across the resistor R9, reducing the loss from resistor R9. The capacitor C5 is included in the feedback circuit to help stabilize the control of the IC U1. The resistor R4 is the output gain control resistor of the differential OP amp X1 to adjust the gain of the differential OP amp X1. The resistor R5 is connected to a node between resistors R23, R18. The output signal of OP amp X1 is controlled by resistor R5. Resistor R5 may not always be necessary, if the signal is precisely controlled by resistors R1, R4, R7 and R6. But resistor R5 can be used additionally to control signal more accurately.

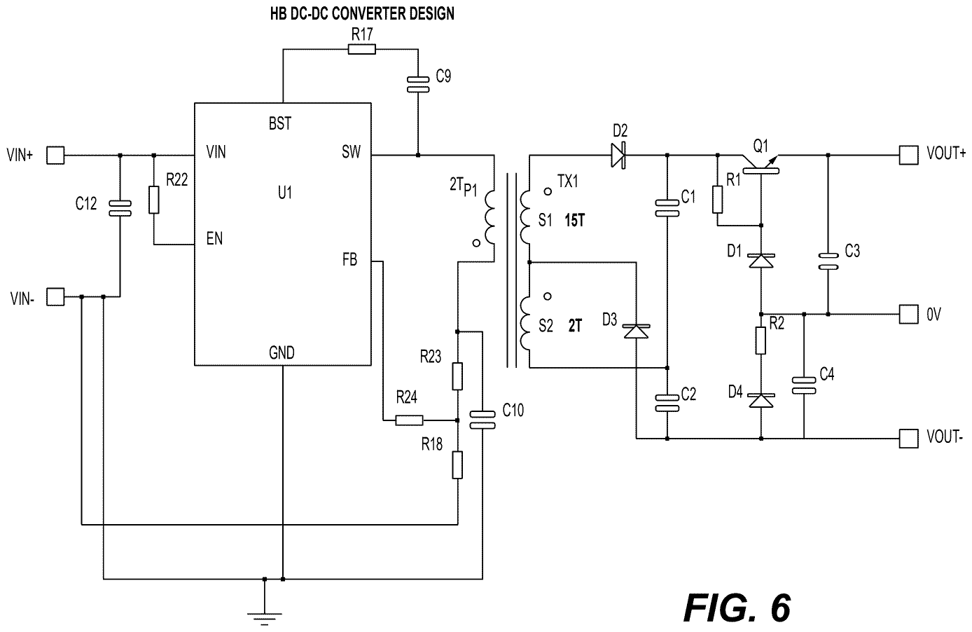

FIG. 6 shows a converter similar to the converters in FIGS. 3A and 3B but that can be used in gate-driver applications. In addition to the output terminals Vout+, Vout−, the converter can include an output terminal 0V. The output terminal Vout-can be used to switch off power switches such as insulated-gate bipolar transistors IGBTs, SiC transistors, or GaN transistors. The output terminal 0V can be used to switch off these power switches, but noise can increase the voltage on the output terminal OV to a voltage level that causes the power switch to turn ON.

The output terminal Vout− can help avoid this undesirable turn ON of power switches. The output voltage of the voltage-doubler circuit is regulated by a series regulator including switch Q1, Zener diode D1, resistor R2, and Zener diode D4 that are connected in series between the output terminals Vout+, Vout−. A node between the Zener diode D1 and resistor R2 is connected to the output terminal 0V. The switch Q1 can be a bipolar junction transistor (BJT).

The series regulator can include resistor R1. The resistor R1 can be connected to the collector of the switch Q1 and connected to a node between the switch Q1 and the Zener diode D1 to limit current to the Zener diode D1. Zener diode D1 needs to include a certain current to provide stable voltage. The resistor R2 provides short-circuit protection to the Zener diode D4. When output terminals Vout+, 0V are shorted, a large current can flow into Zener diode D4, and the resistor R2 can reduce the current in such circumstance. The Zener diode D4 provides the voltage at the output terminal 0V. Capacitor C3 can be connected in parallel with output terminals Vout+, 0V as a filter capacitor to provide a stable voltage at the output terminal Vout+, and capacitor C4 can be connected in parallel with output terminals 0V, Vout− as a filter capacitor to provide a stable voltage at the output terminal Vout−.

In applications in which tight load regulation is required, resistor R1, switch Q1, and Zener diode D1 can be replaced by a single resistor to simplify the circuit.

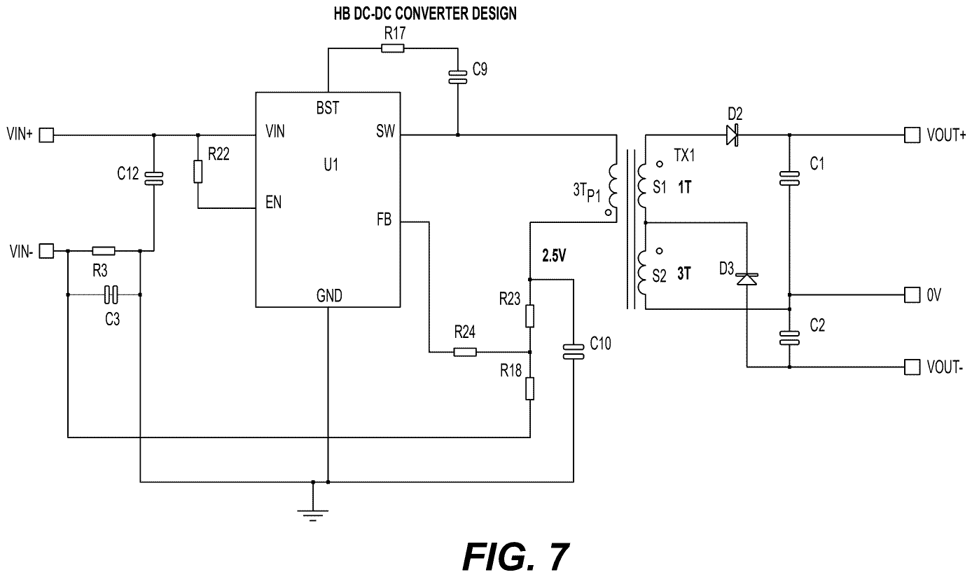

FIG. 7 shows a converter similar to the converter in FIG. 4 but that can be used in gate-driver applications. As with the converter in FIG. 6, in addition to the output terminals Vout+, Vout−, the converter in FIG. 7 can include an output terminal 0V connected to the node between the first and the second capacitors C1, C2. The output terminal Vout− can be used to switch off power switches such as insulated-gate bipolar transistors IGBTs, SiC transistors, or GaN transistors. The output terminal 0V can be used to switch off these power switches, but noise can increase the voltage on the output terminal 0V to a voltage level that causes the power switch to turn ON. The output terminal Vout− can help avoid this undesirable turn ON of power switches.

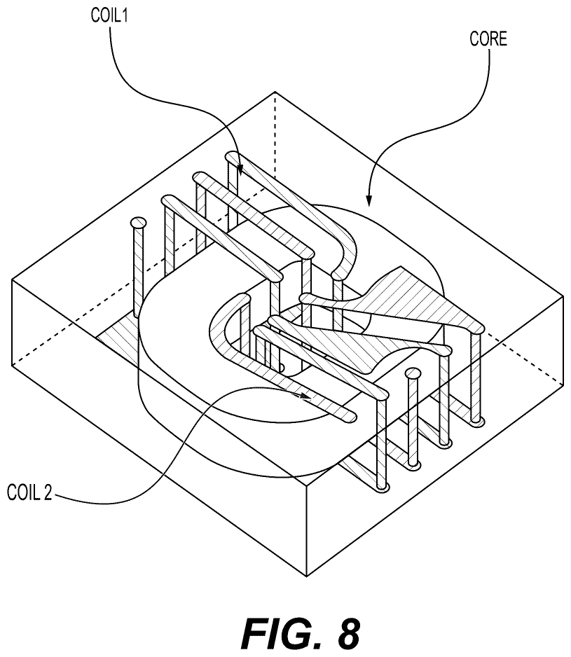

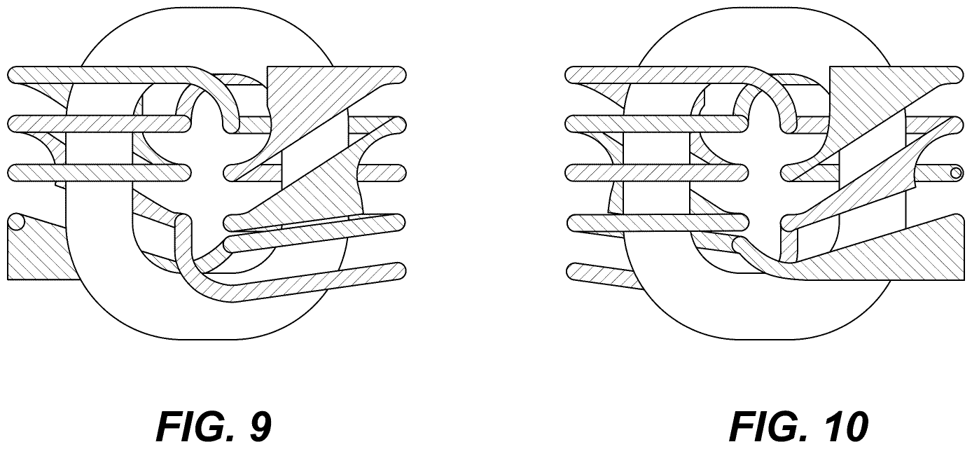

FIGS. 8-11 show an example of a transformer that can be used with the voltage-doubler circuit shown in FIG. 2. The transformer of FIGS. 8-11 can be embedded in a substrate as disclosed in U.S. Application No. 63/210,805, the entire contents of which are hereby incorporated by reference. As shown in FIGS. 8-10, the primary winding Coil 1 can include four turns, and the secondary winding Coil 2 can include three turns. But the primary winding Coil 1 and the secondary winding Coil 2 can include any number of turns. The secondary coil 2 can be tapped to divide the secondary winding Coil 2 into first and second secondary windings. The secondary winding Coil 2 can be tapped anywhere such that the first and the second secondary windings can have any number of turns. The first and the second secondary windings can include a different or the same number of turns. Because the secondary windings do not require a large number of turns, the primary windings can include a similar number of turns as the secondary windings. The transformer can be embedded in a substrate with the primary and the secondary windings including traces and vias within or on the substrate. The transformer can be embedded in any suitable substrate, including, for example, a printed circuit board. With an embedded structure, the primary and secondary windings can be interleaved as shown in FIGS. 8-10, while maintaining a 0.4-mm distance between the primary and the secondary windings as required by safety standard for reinforced isolation. The embedded structure also improves the gain coupling factor of the transformer and the load regulation of the converter.

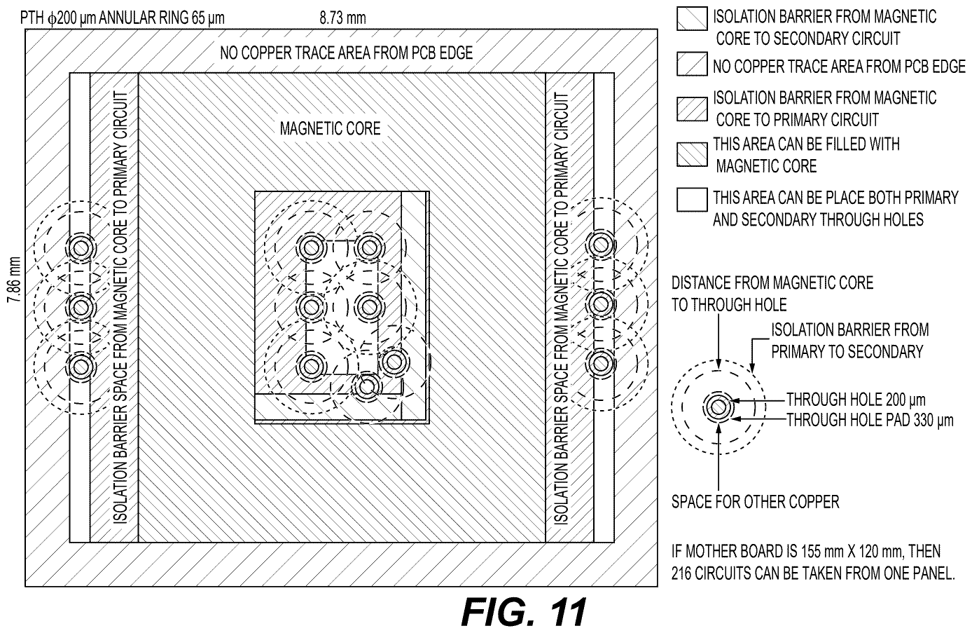

FIG. 11 shows an example layout of a PCB including the transformer shown in FIGS. 8-10. As shown, the PCB can have a size of about 7.86 mm×about 8.73 mm, within manufacturing and/or measurement tolerances. The size of the PCB in FIG. 11 allows 216 PCBs to be created from a single mother PCB that is 155 mm×120 mm. FIG. 11 shows that the area around the perimeter of the PCB in which no copper traces are included, the area in which the magnetic core can be included, the isolation barrier between the primary circuit and the magnetic core, the isolation barrier between the secondary circuit and the magnetic core, and the area in which through holes of vias in the primary and secondary circuits can be included.

FIG. 11 also includes concentric circles around the through holes. Starting with the concentric circle closest to the through holes, the first concentric circle shows the through hole pad (which can be about 330 μm, within manufacturing and/or measurement tolerances), the second concentric circle shows the space that can be used to add additional copper, the third concentric circle shows the distance from the through hole to the magnetic core, and the fourth concentric circle shows the isolation barrier from the primary through holes to the secondary through holes.

Simulations of the transformer shown in FIGS. 8-10 were conducted with the current in the primary and secondary windings being 0.5 A, the turns ratio being 3:4, the core height being 1.6 mm, the cavity depth being 2.02 mm, the primary and secondary windings being made of copper, and the core being made of μi 900 (P61 Acme). The simulations show that the primary winding has an inductance of 1.410 μH and a resistance of 46.2 mΩ, the secondary winding has an inductance of 2.489 μH and a resistance of 54.7 mΩ and the transformer has a coupling factor of 0.986 and a mutual inductance of 1.848 μH.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1: A circuit comprising:
first and second output terminals;
a transformer including a primary winding and a secondary winding, the secondary winding includes a tap that divides the secondary winding into first and second secondary windings;
a rectifier circuit connected to the secondary winding; and
a voltage-doubler circuit connected to the tap such that the voltage-doubler circuit receives a first voltage from both the first and the second secondary windings and a second voltage from only the second secondary winding.

2: The circuit of claim 1, wherein the voltage-doubler circuit includes first and second capacitors connected in series with each other and connected in parallel with the first and second output terminals.

3: The circuit of claim 2, wherein the first voltage is applied to the first capacitor and the second voltage is applied to the second capacitor such that an output voltage across the first and the second output terminals is a sum of the first voltage and the second voltage.

4: The circuit of claim 2, wherein the rectifier circuit includes first and second diodes.

5: The circuit of claim 4, wherein
each of the first and the second capacitors includes first and second ends;
each of the first and the second diodes includes an anode and a cathode;
the anode of the first diode is connected to the first end of the first secondary winding;
a cathode of the second diode is connected to the second end of the first secondary winding and to the first end of the second secondary winding;
the first terminal of the first capacitor is connected to the cathode of the first diode and to the first output terminal;
the second terminal of the first capacitor is connected to the first terminal of the second capacitor;
a node defined by a connection between the second terminal of the first capacitor and the first terminal of the second capacitor is connected to the second end of the second secondary winding; and
the second terminal of the second capacitor is connected to the anode of the second diode and the second output terminal.

6: The circuit of claim 1, further comprising a substrate; wherein
the transformer is embedded in the substrate.

7: The circuit of claim 6, wherein the primary winding and the secondary winding are interleaved.

8: A converter comprising:
first and second input terminals;
the circuit of claim 1; and
an integrated circuit (IC) connected to the first and the second input terminals and the primary winding.

9: The converter of claim 8, further comprising a load-compensation circuit connected to the second input terminal.

10: The converter of claim 9, wherein the load-compensation circuit includes:
a resistor connected to the second input terminal; and
an operational amplifier connected across the resistor.

11: The converter of claim 8, further comprising a third output terminal.

12: The converter of claim 11, wherein the third output terminal is connected to the voltage-doubler circuit.

13: The converter of claim 11, further comprising a series regulator; wherein
the third output terminal is connected to the series regulator.

14: The converter of claim 8, wherein
during an OFF period of the IC, the first voltage is applied to the first capacitor; and
during an ON period of the IC, the second voltage is applied to the second capacitor.
